(19) United States
(12) Patent Application Publication
(10) Pub. No.: US 2025/0353605 A1
(43) Pub. Date: Nov. 20, 2025

(54) AVIATION EQUIPMENT PROTECTION SYSTEM

(71) Applicant: Roy Eliason, South Haven, MN (US)

(72) Inventor: Roy Eliason, South Haven, MN (US)

(21) Appl. No.: 19/281,826

(22) Filed: Jul. 28, 2025

Related U.S. Application Data
(63) Continuation-in-part of application No. 17/142,608, filed on Jan. 6, 2021, now abandoned.
(60) Provisional application No. 63/033,581, filed on Jun. 2, 2020.

(51) Int. Cl. B64D 33/02; B05B 1/04

(52) U.S. Cl. CPC B64D 33/02; B05B 1/044; B64D 2033/022; B64D 2033/0273

(57) ABSTRACT

A method of protecting aviation equipment. An aircraft is provided having an engine attached thereto. The engine has an engine inlet, a nose cone and a nozzle. The nose cone is operably mounted to the engine. The nozzle is mounted to the nose cone. An object in proximity to the engine inlet is sensed with a sensor. In response to sensing the object, the nose cone is moved from a retracted position to an extended position. In response to sensing the object, tubing provides a liquid to the nozzle and the liquid is emitted from the nozzle.

### REFERENCE TO RELATED APPLICATION

This application is a continuation-in-part of U.S. application Ser. No. 17/142,608, filed Jan. 6, 2021, and claims priority to Provisional Application. No. 63/033,581, filed on Jun. 2, 2020, the contents of which are incorporated herein by reference.

### FIELD OF THE INVENTION

The invention relates generally to systems for protecting aviation equipment from damage. More particularly, the invention relates to an aircraft equipment protection system.

### BACKGROUND OF THE INVENTION

Airplanes and, in particular, airplane engines while configured to be highly resistant to damage are particularly vulnerable to damage caused by objects being ingested into the airplane engines. One significant source of risk is birds being ingested into the airplane engines. Particularly when the airplane is taking off, the ingestion of birds into the airplane engines can have catastrophic consequences such as the airplane crashing. The prior art methods and process of protecting airplane engines from ingesting birds are less than effective.

### SUMMARY OF THE INVENTION

An embodiment of the invention is directed to a method of protecting aviation equipment. An aircraft is provided having an engine attached thereto. The engine includes an engine inlet, a nose cone and a nozzle. The nose cone is operably mounted to the engine. The nozzle is mounted to the nose cone. An object in proximity to the engine inlet is sensed with a sensor. In response to sensing the object, the nose cone is moved from a retracted position to an extended position. In response to sensing the object, tubing provides a liquid to the nozzle and the liquid is emitted from the nozzle.

Another embodiment of the invention is directed to an aviation equipment protection system that includes an aircraft having an engine attached thereto. The engine includes an engine inlet, a nose cone, a nozzle and tubing. The nose cone is operably mounted to the engine for movement between a retracted position and an extended position. The nozzle is mounted to the nose cone. The tubing is operably connected to the nozzle for delivering a liquid to the nozzle. A sensor is capable of operably controlling movement of the nose cone between the retracted position and the extended position and emission of liquid.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. The elements of the drawings are not necessarily to scale relative to each other. Like reference numerals designate corresponding similar parts.

FIG. 1 is a side view of an airplane that includes an aviation equipment illumination personnel protection system according to an embodiment of the invention.

FIG. 2 is a partially broken away perspective view of an airplane engine that includes the aviation equipment illumination personnel protection system.

FIG. 3 is a front view of an airplane wing with an engine attached thereto that includes the aviation equipment illumination personnel protection system.

FIG. 4 is a front view of an airplane wing with an engine attached thereto that includes an alternative embodiment of the aviation equipment protection system.

FIG. 5 is a back perspective view of the aircraft engine in the embodiment of FIG. 4.

FIG. 6 is a sectional view of the aircraft engine taken along a line A-A in FIG. 4.

### DETAILED DESCRIPTION OF THE INVENTION

An embodiment of the invention is directed to aviation equipment illumination personnel protection as illustrated in the drawings. Through the use of the aviation equipment illumination personnel protection system, it is possible to avoid injury and/or death to persons in proximity to an aircraft 10 caused by contact by a portion of the aircraft 10 such as an engine 22 and/or being sucked into the engine 22. In certain embodiments, the aircraft 10 is an airplane.

As referenced above, even though the engine 22 makes noise when operating, the personnel in proximity to the airplane 10 typically wear hearing protection devices, which reduces the potential of the noise causing the personnel to be aware of the engine 22 being in proximity to the personnel.

The invention utilizes lights 24 mounted to the airplane 10 to illuminate potentially hazardous parts of the airplane 10 that pose a hazard to personnel such as the engine 22 and thereby make the person aware of the hazard such that the person can avoid the hazard.

The lights 24 may be mounted on the surface of the airplane 10. Alternatively, lights 24 may be recessed into a surface of the airplane 10 such that an outer surface of the light 24 is aligned with the outer surface of the airplane 10.

In one configuration, the lights 24 are mounted to the engine 22. In one embodiment, the lights 24 are mounted to the engine 22 proximate an inlet end thereof such as on a leading edge of the engine 22. Alternatively or additionally, the lights 24 may be mounted on an outer surface of the engine 22 proximate the inlet end thereof. It is also possible for the lights 24 to be mounted on an inner surface of the engine 22 proximate the inlet end and/or outlet end thereof.

In certain embodiments, the lights 24 are mounted to the engine 22 in a spaced-apart configuration that extends substantially around the inlet end of the engine 22. In other embodiments, the lights 24 are mounted to the engine 22 only on parts of the engine 22 that are likely to be contacted by personnel such as the lower part of the engine 22.

The lights 24 may also be mounted proximate an outlet end of the engine 22 in situations where the outlet end of the engine 22 presents a risk of injury. For example, gas flows out of the outlet end at a high velocity such that it poses a risk of knocking over a person or otherwise causing injury or death to the person.

FIG. 2 illustrates that the lights 40 may additionally or alternatively be mounted on the outer surface of the engine 22. In certain embodiments, the lights 40 are mounted on the outer surface of the engine 22 proximate a front end thereof.

FIG. 2 also illustrates lights 42, 44 on the interior of the engine 22 to illuminate the blades 46. One set of lights 42 is mounted to the engine 22 forward of the blades 46 and one set of lights 44 is mounted to the engine 22 aft of the blades 46. In addition to reducing the potential of persons contacting the engine 22, the lights 42, 44 may be beneficial to evaluate the condition of the blades 46 for damage such as from birds or debris.

Depending on whether the engine 22 is manufactured with the lights or if the lights are later added to the engine 22, the engine 22 may include at least one aperture 36 that is proximate where the lights are attachable to the engine 22 to receive wiring associated with the lights.

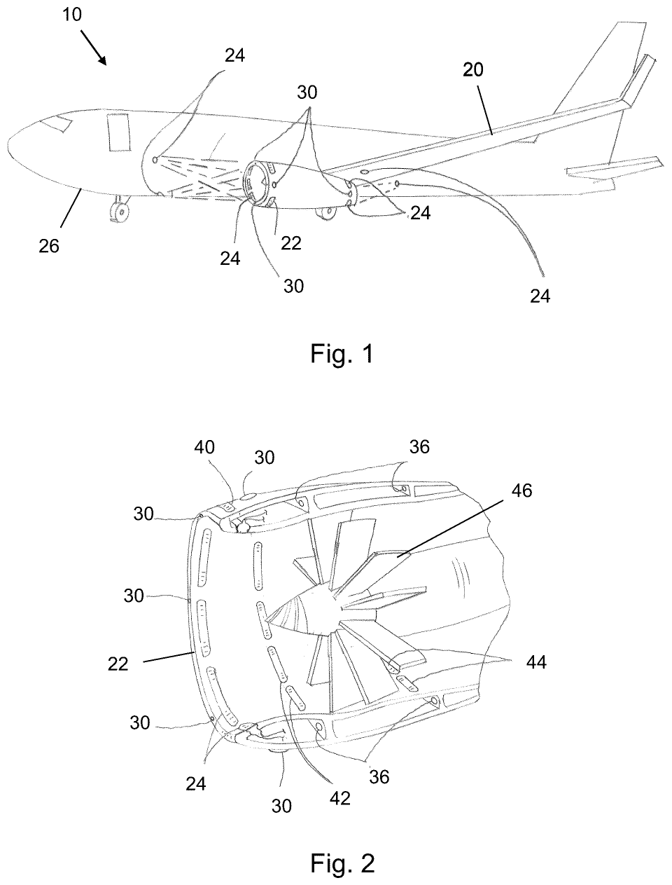

It is also possible for the lights 24 to be mounted to the airplane fuselage 26 sufficiently close to the engine 22 to illuminate potentially hazardous portions of the engine 22 such as illustrated in FIG. 1 where the lights 24 are mounted to the fuselage 26 forward and aft of the engine 22.

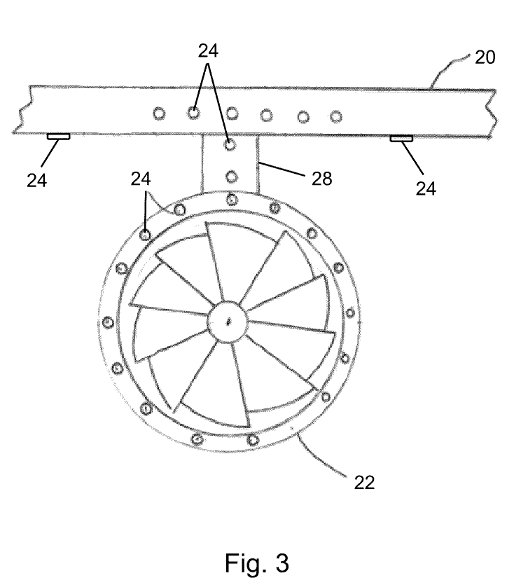

While FIG. 3 illustrates the lights 24 mounted on the front of the engine 22, it is also possible to mount the lights 24 on the wing 20 or a pylon 28 that attaches the engine 22 to the wing 20. In addition to mounting the lights 24 emitting light in a direction that faces in a direction towards a front of the engine 22, it is also possible to orient the lights in other directions such as facing downward. In such situations, the lights 24 may be mounted to the wing 20 inside and/or outside of where the engine 22 is attached to the wing 20.

The lights 24 may be continuously illuminated to provide the warning of the potentially hazardous airplane parts. Alternatively, the lights 24 may only be illuminated when there is a person in proximity to the potentially hazardous parts on the airplane 10. By illuminating the lights 24 when persons are in proximity to the potentially hazardous parts on the airplane 10, the lights 24 may more effectively warn the person of the hazard in proximity thereto as compared to when the lights are continuously illuminated.

Even in situations where the lights 24 are continuously illuminated, the lights 24 may only be illuminated when the potentially hazardous parts of the airplane 10 are in operation such as the engine 22 being turned on.

To facilitate illuminating the lights 24 when the person is in proximity to the potentially hazardous parts on the airplane 10, at least one motion sensor 30 may be mounted to the airplane 10. In certain embodiments, the motion sensor 30 may be incorporated into the light 24. In other embodiments, the motion sensor 30 is separate from the light 24.

The motion sensor(s) is positioned on the airplane 10 facing directions in which the personnel would likely be located. However, the motion sensor 30 does not need to be mounted in proximity to the lights 24. It is also not necessary for the motion sensor 30 to be mounted to the same part of the airplane 10 as the lights 24. A person of skill in the art will appreciate that there are a variety of types of motion sensors 30 may be used in conjunction with the invention.

In one form, the motion sensor 30 causes the lights 24 to turn on in response to sensing the person being in proximity to the potentially hazardous part of the airplane 10. In other embodiments, the motion sensor 30 causes the illumination of the lights 24 to change based upon the distance between the person and the potentially hazardous part of the airplane 10.

In one such configuration, the illumination intensity of the light 24 increases as the person gets closer to the potentially hazardous part of the airplane 10. In another configuration, the illumination color of the light 24 changes as the person gets closer to the potentially hazardous part of the airplane 10. For example, the illumination color may change from green to yellow and then to red as the person gets closer to the potentially hazardous part of the airplane 10 similar to the manner in which a conventional stop light operates.

In yet another configuration, the illumination pattern changes as the person gets closer to the potentially hazard part of the airplane 10. For example, the light 24 may flash at an increasingly faster rate as the person gets closer to the potentially hazardous part of the airplane 10. In still another embodiment, the number of lights 24 that are illuminated may increase as the person gets closer to the potentially hazardous part of the airplane 10.

The lights 24 may also be operably connected to the engine 22 such that the operation of the lights 24 is related to the power level at which the engine 22 is operated. For example, the lights 24 may not illuminate when the engine 22 is operated at a low power level and when the power level at which the engine 22 is operated increases, the illumination intensity, pattern and/or color of the lights 24 may change to reflect the increased danger associated with the engine 22 operating at a higher power level.

In contrast to the lights conventional provided on aircraft that are intended to facilitate navigation of the aircraft 10 such as when moving on the ground, the lights 24, 42 and 44 of this invention are not intended or positioned to facilitate navigation of the aircraft 10. Rather, the lights 24, 42 and 44 illuminate parts of the aircraft such as the engine 22 to thereby avoid injury and/or death to personnel who are proximate the aircraft while the aircraft is on the ground.

It is also possible to include a maintenance light on the aircraft 10 and/or on the engine 22 that is used in conjunction with diagnosis and/or maintenance of the engine 22. The maintenance light may be the same as the lights 24, 42 and 44 or the maintenance light may be different than the lights 24, 42, 44. When the maintenance light is the same as the lights 24, 42 and 44, the aircraft 10 may include a switch to change from operation mode to maintenance mode.

The maintenance light may indicate an operating condition of the engine 22. For example, if all systems of the engine 22 are operating correctly, the maintenance light may illuminate green. The maintenance light may change color, illumination pattern and/or illumination color if one of more aspects of the engine 22 are not operating correctly. Alternatively or additionally, the maintenance light may change illumination color, illumination pattern and/or illumination intensity based upon a rotational speed of the engine 22.

Because of the combination illumination color, illumination pattern and illumination intensity, the concepts discussed herein are suitable for use by colorblind persons as well as for use by persons who are not colorblind.

Another embodiment of the invention is directed to a system and method of protecting airplanes and, in particular, airplane engines from bird strikes. When birds are detected proximate to the airplane, the protection system is activated. In certain embodiments, the birds are detected such as using radar. In other embodiments, the birds are detected through visual observation.

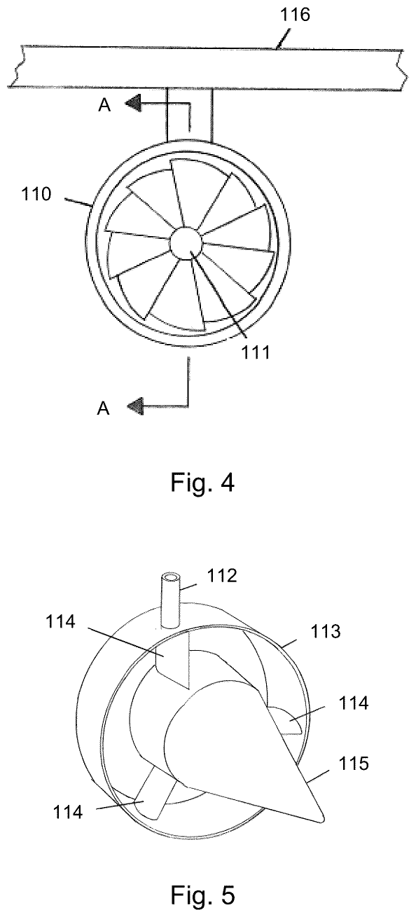

In one embodiment, the airplane engine 110 is attached to a wing 116 on the airplane as illustrated in FIG. 4. The airplane engine 110 may include an exhaust collector 113 from which a plurality of struts 114 inwardly extend as illustrated in FIG. 5. An exhaust cone 115 is provided on a central section of a back end of the airplane engine 110. FIG. 5 also illustrates tubing 112 extending from the airplane engine 110.

While the invention is particularly suited for use in protecting the airplane engine 110 from bird strikes, it is also possible to adapt the invention for protecting the airplane engine 110 from volcanic ash, engine fires and de-icing.

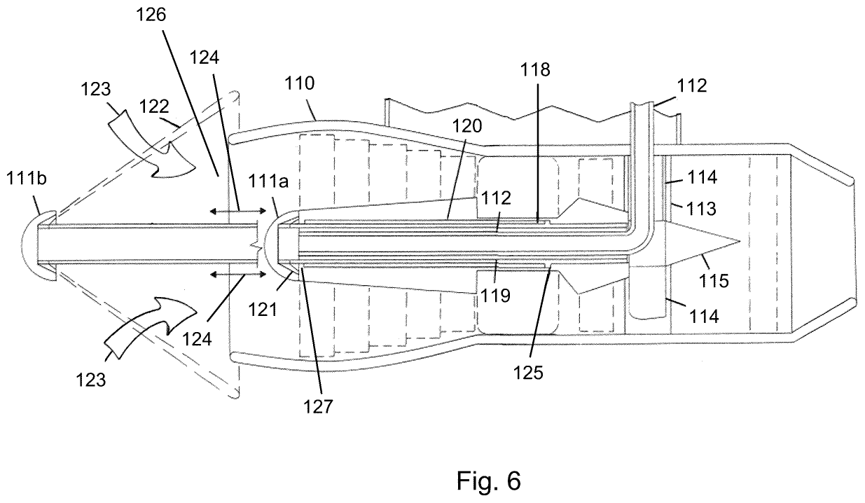

When birds are detected, a nose cone 111 is extended from a retracted position 111a to an extended position 111b, as illustrated by arrows 124 in FIG. 6. The extension of the nose cone 111 can be done at any time in the airplane's flight from takeoff, cruising and landing.

A variety of techniques may be used to move the nose cone 111 from the retracted position 111a to the extended position. An example of one suitable technique for moving the nose cone 111 from the retracted position 111a to the extended position 111b is pressurized water. The pressurized water is delivered such as through tube 112.

In addition to water, it is possible for other liquids to be used in conjunction with this invention. Examples of other liquids include aircraft de-icing fluid and engine fire suppression agent. These other liquids can be used by themselves or in conjunction with water.

To facilitate the movement of the nose cone 111 from the retracted position 111a to the extended position, a sliding tube that includes a first tube section 118 and a second tube section 119. FIG. 6 illustrates the second tube section in a retracted position and in an extended position.

Also included to facilitate the movement of the second tube section 119 with respect to the first tube section 118 is a bearing. A person of skill in the art will appreciate that the bearing may assume a variety of forms using the concepts of the invention, examples of which include rotational bearings and linear bearings.

An extension tube ring 125 extends from an outer surface of the second tube section 119 to limit a distance that the second tube section 119 can be extended with respect to the first tube section 118 by the ring 125 coming into contact with shoulder 127. An opening or gap 120 is provided that allows travel of the extension tube and shoulder/ring 125.

The pressure to cause the water to flow may come from a variety of sources. One power source is from the aircraft engine 110. Alternatively, the pressure may be provided by a pump (not shown) that is separate from the aircraft engine 110.

When activated, an air permeable water curtain 122, which is emitted from at least one nozzle 121, surrounds the engine intake as illustrated in FIG. 6. The pressure at which the water is emitted needs to be greater than the intake thrust of the airplane engine 110 so that the water is not sucked into the airplane engine 110. However, if a small portion of the water is sucked into the airplane engine 110, the water will not cause any damage to the airplane engine 110 because airplane engines are designed to intake water such as from rain and snow.

The water is emitted from the nozzle 121 at an angle so that the air permeable water curtain is directed outside of the engine inlet in as illustrated in FIG. 6. The angle should account for a force from the intake thrust of the airplane engine 110 as well as a force caused by the movement of the aircraft.

The air permeable water curtain 122 permits air to flow (as indicated by arrow 123) therethrough but redirects objects such as birds away from the intake of the airplane engine 110. The water flow may be continuous or it may be intermittent. For example, the air permeable water curtain 122 may be provided by a series of jets that allow the air to pass between the jets.

In the preceding detailed description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The preceding detailed description, therefore, is not to be taken in a limiting sense, and the scope of the present invention is defined by the appended claims.

It is contemplated that features disclosed in this application, as well as those described in the above applications incorporated by reference, can be mixed and matched to suit particular circumstances. Various other modifications and changes will be apparent to those of ordinary skill.

1. A method of protecting aviation equipment comprising:
providing an aircraft having an engine attached thereto, wherein the engine comprises an engine inlet, a nose cone and a nozzle, wherein the nose cone is operably mounted to the engine and wherein the nozzle is mounted to the nose cone;
sensing an object in proximity to the engine inlet with a sensor;
in response to sensing the object, moving the nose cone from a retracted position to an extended position; and
in response to sensing the object, using tubing to provide a liquid to the nozzle and emitting the liquid from the nozzle.

2. The method of protecting aviation equipment of claim 1, wherein the tubing comprises a first tubing section and a second tubing section, wherein moving the nose cone from the retracted position to the extended position comprises sliding the second tubing section with respect to the first tubing section.

3. The method of protecting aviation equipment of claim 2, and further comprising limiting a distance that the second tubing section is slidable with respect to the first tubing section with a shoulder or ring on at least one of the first tubing section and the second tubing section.

4. The method of protecting aviation equipment of claim 1, wherein moving the nose cone between the retracted position and the extended position comprises sliding the nose cone.

5. The method of protecting aviation equipment of claim 1, wherein the nose cone comprises a trailing end that is oriented towards the engine inlet and wherein the nozzle is located at the trailing end of the nose cone.

6. The method of protecting aviation equipment of claim 1, wherein the liquid is emitted at a pressure that minimizes the liquid being ingested into the engine.

7. The method of protecting aviation equipment of claim 1, wherein the emission of liquid is at an angle that minimizes the liquid being ingested into the engine.

8. The method of protecting aviation equipment of claim 1, wherein the emission of liquid is continuous or intermittent and wherein the liquid is water.

9. The method of protecting aviation equipment of claim 1, wherein the liquid is emitted in an air permeable water curtain.

10. The method of protecting aviation equipment of claim 11, wherein the air permeable water curtain substantially surrounds the engine inlet.

11. The method of protecting aviation equipment of claim 1, wherein the emitting the liquid from the nozzle protects the engine from being damaged by birds, fires, volcanic ash and icing.

12. An aviation equipment protection system comprising:
an aircraft having an engine attached thereto, wherein the engine comprises:
an engine inlet;
a nose cone operably mounted to the engine for movement between a retracted position and an extended position;
a nozzle mounted to the nose cone; and
tubing operably connected to the nozzle for delivering a liquid to the nozzle; and
a sensor that is capable of operably controlling movement of the nose cone between the retracted position and the extended position and emission of liquid.

13. The aviation equipment protection system of claim 12, wherein the tubing comprises a first tubing section and a second tubing section, wherein the second tubing section is slidably mounted with respect to the first tubing section for changing a length of the tubing.

14. The aviation equipment protection system of claim 13, wherein at least one of the first tubing section and the second tubing section comprises a shoulder or ring extending therefrom to limit a distance that the second tubing section is slidable with respect to the first tubing section.

15. The aviation equipment protection system of claim 12, wherein the nose cone is slidable between the retracted position and the extended position.

16. The aviation equipment protection system of claim 12, wherein the nose cone comprises a trailing end that is oriented towards the engine inlet and wherein the nozzle is located at the trailing end of the nose cone.

17. The aviation equipment protection system of claim 12, wherein the nozzle comprises a plurality of nozzles that are provided around the nose cone and wherein the nozzle is oriented at an angle to minimize the liquid being ingested into the engine.

18. The aviation equipment protection system of claim 12, wherein the nozzle is capable of emitting an air permeable water curtain that substantially surrounds the engine inlet.

19. The aviation equipment protection system of claim 12, wherein the liquid is water.

20. The aviation equipment protection system of claim 12, wherein the aviation equipment protection system protects the engine from being damaged by birds, fires, volcanic ash and icing.
